(19) United States
(12) Patent Application Publication
(10) Pub. No.: US 2007/0037622 A1
(43) Pub. Date: Feb. 15, 2007

(54) Simultaneous move chess system and method

(76) Inventor: Dominic Chan, Marina del Rey, CA (US)

Correspondence Address: CHRISTIE, PARKER & HALE, LLP, PO BOX 7068, PASADENA, CA, 91109-7068, US

(21) Appl. No.: 11/493,150

(22) Filed: Jul. 25, 2006

Related U.S. Application Data
(60) Provisional application No. 60/702,392, filed on Jul. 25, 2005.

(51) Int. Cl. G06F 19/00

(52) U.S. Cl. 463/14

(57) ABSTRACT

A system and method of playing of a game of simultaneous move chess involve receiving intended move commands from at least two players, determining the results of the intended move commands after intended move commands are received for all players in the game. The determination includes interpreting intended moves that result in a player's piece landing in square occupied by another of that player's pieces as a guard move. If an attacking player's intended move is to an attacked square occupied by a defending player's piece and the defending player's intended move is a guard move to the same square, the attacking player's piece in the attacking player's intended move is eliminated, the defending player's piece in the attacked square is eliminated and the defending player's piece making the intended guard move is moved to the attacked square. If a defending player's intended move is a guard move of square that is not an ending square of an attacking player's intended move, none of the defending player's pieces are moved until at least the next turn. The determined results of the intended move commands are output as instructions for updating a chess board.

### CROSS-REFERENCE TO RELATED APPLICATION(S)

This application claims priority to and the benefit of U.S. Provisional Application No. 60/702,392, filed on Jan. Jul. 25, 2005, the entire disclosures of which are incorporated fully herein by reference.

### BACKGROUND

The game of chess is one of the most popular board games in the world for centuries. Many countries and localities have special variations, such as Chinese chess, Indian chess and others. Chess games as a family (including International chess, Chinese chess, Indian chess and other variations of the chess family) possess a number of central characteristics:

(1) Played by two players;

(2) Each player has the same number of pieces;

(3) Each piece has fixed rules for moving;

(4) Each player takes turn moving (“sequential move”); and

(5) When a first piece move onto the position occupied by the second piece, the second piece is eliminated (taken) by the first piece (“resolution”).

Chess, by its pieces and nature, is meant to mimic a military conflict. Arguably, rule number (4)—the “sequential move rule”, may be the most “unrealistic” when it comes to reflecting military reality. Seldom, if ever, would one side know all of the information of the other side before making a decision.

Chess is a deterministic game. The only “chance” in the game is when an opponent fails to see a potential trap. For this reason, chess is considered a “serious” game, with the result somewhat indicative, without many excuses, of the ranking of skills—or even intelligence.

### SUMMARY OF THE INVENTION

A system and method of hardware, software and rules is called “simultaneous chess”. In short, the system replaces the “sequential move rule” (rule number 4 above) by a “simultaneous move rule” in that each player simultaneously, and without foreknowledge of each other's move, makes a move. To accomplish this, the “resolution rule” is modified in one or another manner.

A system and method of playing of a game of simultaneous move chess involve receiving intended move commands from at least two players, determining the results of the intended move commands after intended move commands are received for all players in the game. The determination includes interpreting intended moves that result in a player's piece landing in square occupied by another of that player's pieces as a guard move. If an attacking player's intended move is to an attacked square occupied by a defending player's piece and the defending player's intended move is a guard move to the same square, the attacking player's piece in the attacking player's intended move is eliminated, the defending player's piece in the attacked square is eliminated and the defending player's piece making the intended guard move is moved to the attacked square. If a defending player's intended move is a guard move of square that is not an ending square of an attacking player's intended move, none of the defending player's pieces are moved until at least the next turn. The determined results of the intended move commands are output as instructions for updating a chess board.

### BRIEF DESCRIPTION OF THE DRAWINGS

Features and advantages of the present invention will be better understood by reference to the following detailed description when considered in conjunction with the accompanying drawings herein:

FIG. 1 shows a block diagram of a system for playing simultaneous move chess according to a single processor embodiment of the invention.

FIG. 2 shows a block diagram of a system for playing simultaneous move chess according to a dual processor embodiment of the invention.

FIG. 3 shows a block diagram of a system for playing simultaneous move chess according to a three processor embodiment of the invention.

FIG. 4 shows a flow diagram of the move evaluation process according to an embodiment of the invention.

### DETAILED DESCRIPTION OF THE INVENTION

In many embodiments, the execution of the “simultaneous chess” is assisted by an electronic system capable of (1) displaying the chess board either through graphics or script, (2) accepting move orders from each player, either simultaneously or sequentially, to be executed simultaneously, without one player knowing the move order of the other player, and (3) executing the moves, and applying the applicable resolution rule to generate resulting chess board for display to both players.

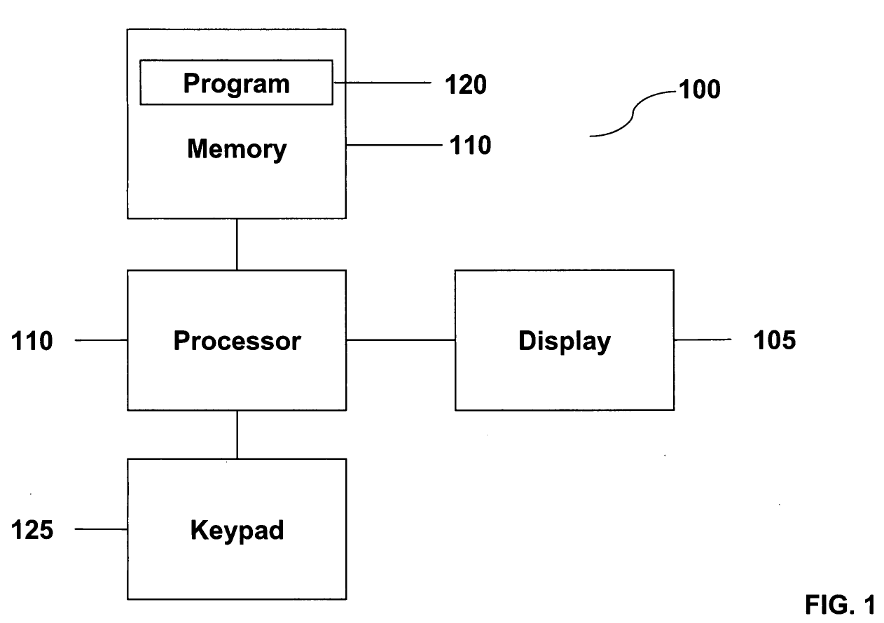

FIG. 1 shows one such electronic system 100. The system includes a display 105 that displays the chess pieces. The chess board is either also displayed by display 105 or is superimposed on or by the displayed chess pieces. The display is connected to a processor 110 that executes a program 120 contained in memory 115. Program 120 receives inputs, including move orders from players from keypad 125. Processor 110, executing program 120, determines the results of player moves entered with keypad 125 and displays the resulting position of the chess pieces based on the rules such as those described below, and, optionally, the treatment or explanation of the entered player moves according to the rules. In alternate embodiments, any known input device may be used for keypad 125, including, but not limited to, a keyboard, touchscreen, touchpad, mouse, trackball, or control stick. In some embodiments, keypad 125 and/or display 105 are connected to the processor by a wireless connection. In some embodiments, system 100 has more than one display 105 and/or more than one keypad 125. In embodiments with one keypad 125, players take turns entering moves such that the other player cannot what keys are being pressed. System 100 may be a dedicated game device, a full function computer, or a device with some characteristic of each.

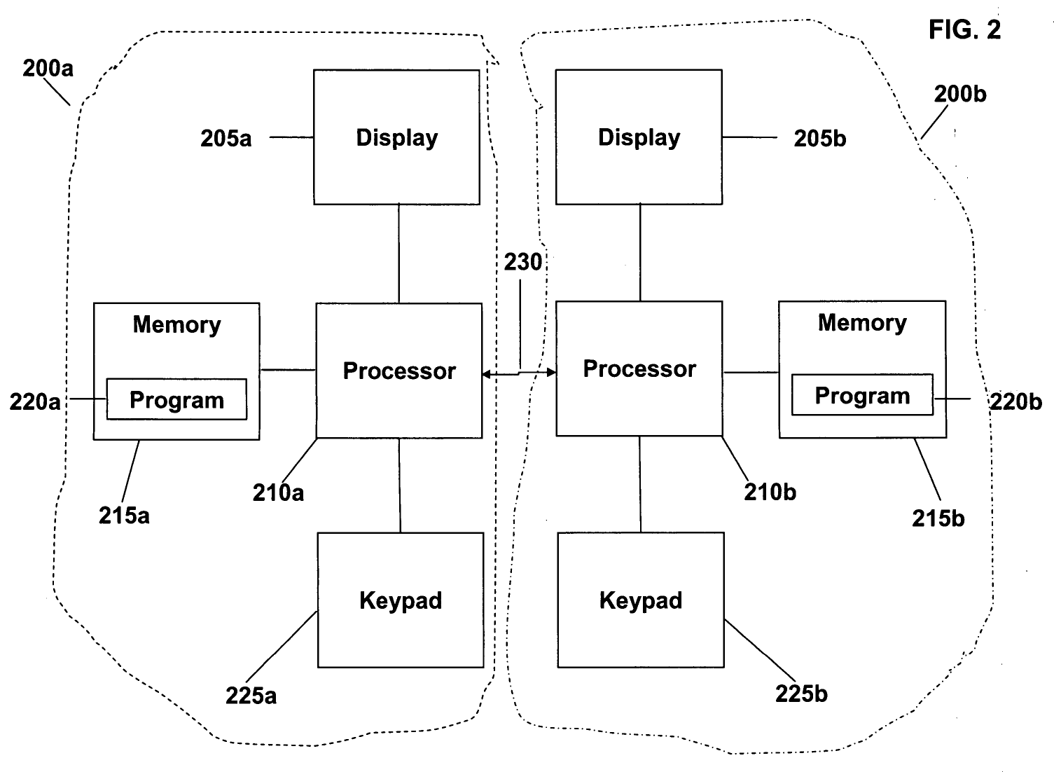

A two processor system according to an alternate embodiment is shown in FIG. 2. This system includes units 200a and 200b, each with displays 205a and 205b, respectively. Displays 205a and 205b are connected to processors 210a and 210b, respectively, that execute programs 220a and 220b contained in memory 215a and 215b, respectively. Units 205a and 205b operate generally the same as and have similar variations as system 100. To allow play between the users of units 205a and 205b, processor 210a and 210b communicate through connection 230. In different embodiments, connection 230 is hard wired or wireless, a direct connection, a private network or a public network, such as the Internet, or local or wide area networks. In some embodiments of the two processor system, one of the processors is a master and the other a slave, in which the master dictates what functions it will perform and what functions the slave will perform. In some embodiments, the two processors are in a peer-to-peer arrangement with a protocol for determining which processor will perform which functions at a particular time. Each unit 200a and 200b may be a dedicated game device, a full function computer, or a device with some characteristic of each. Each unit 200a and 200b may also be a telephone (e.g., WAP-enabled, web browser equipped, smartphone, PDA) or other device with a processor, display, and input that can communicate with other devices. Units 200a and 200b alternatively are any combination of these devices.

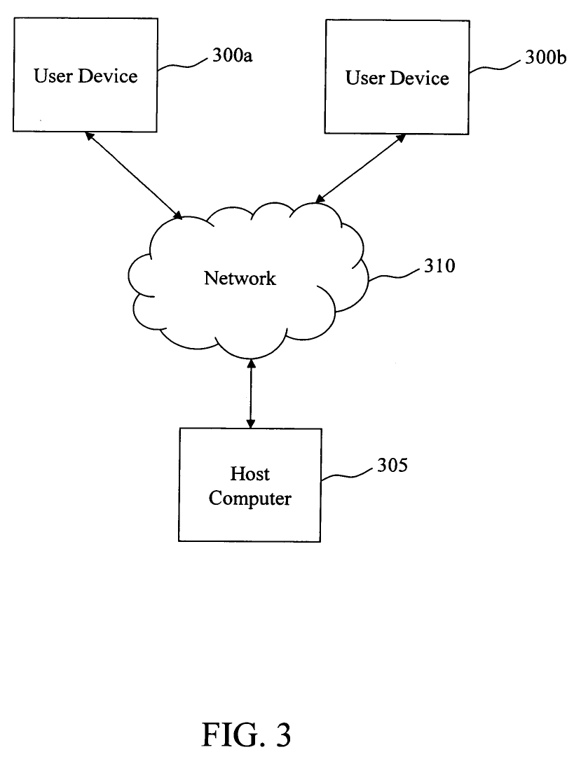

A three processor system according to some embodiments is shown in FIG. 3. In this system, user devices 300a and 300b communicate with host computer 305 through network 310. User devices may be game devices, full function computers or any other device contemplated for use as a system 100 or units 200a and 200b, provided that they have an interface to connect them with network 310. Host computer 305 may be a simple computer on the network or a server, such as a web server. In various embodiments, network 310 is a hard wired, wireless, or combination wired/wireless network. In various embodiments, network 310 is a private network or a public network, such as the Internet, or a local or a wide area network, or some combination of these types of networks. In one exemplary embodiment, unit devices 300a and 300b are personal computers, network 310 is the Internet, and host computer 305 is a web server. Both unit devices 300a and 300b and host computer 305 execute a software program. Players each can view a display of the chess board on their unit device and enter their move into their user devices.

In some embodiments, host computer 305 facilitates that connection of unit devices 300a and 300b, but after that connection is made, host computer is not actively involved in the playing of the game. In these embodiments, unit devices 300a and 300b communicate with one another and negotiate, using a common set of rules, an outcome or resolution of the two moves. The outcome or resolution is then used to update the chess board for display on the two unit devices 300a and 300b. These steps are then repeated until the game is completed or quit. In some embodiments, unit devices 300a and 300b communicate primarily or exclusively with host computer 305, but not with each other. In these embodiments, host computer 305 receives inputs from the unit devices 300a and 300b indicative of an agreed upon common set of rules to be used. Thereafter, host computer 305 receives move inputs from the unit devices 300a and 300b, determines the outcome based on the agreed upon rules and sends instructions to unit devices 300a and 300b for updating their respective chess board displays. This process is repeated until the game is finished or quit.

In some embodiments, devices with processors are not used. Rather, each player make a notation of their intended move in a place that is not seen by the other player. Once both players have finalized their notations, the notations are revealed to the other player and the players resolve the moves according to an agreed upon rule set. Some rule sets, as described below, involve hidden moves that remain hidden for a number of turns, but must be consulted in determining the resolution of a turn before the hidden move is revealed. In such cases, a third player may be used to look at the player notations and determine the results of the moves without revealing any hidden moves. While these no processor embodiments may be usable in some simple rule sets, in many, more complicated rule sets, the no processor embodiments are impractical due to the quantity of notations and the complexity of the determination that must be made.

Turning to the resolution of two simultaneous chess moves, a number of different resolution rules may be in effect and used by the computer programs as described below. Further, a number of additional optional rules may be implemented in combination with main resolution rules or sets of rules. In some embodiments, players may select resolution rules by consensus. In some embodiments, each player may select a resolution rule different from the other player's selection, as long as the rules (and their co-existence) are acceptable to the system.

One or more software programs are used to perform the needed tasks to allow the game to be played, including, but not limited to, chess board display and upgrade, outcome and resolution determination, acceptance of moves (including potential retractions), collateral support including timer functions, help, and other common electronic game support functions.

The functions of the software program likewise may be concentrated or distributed, and may reside in one or more hardware devices. For example, the display function may reside in each unit controlling a display, while the outcome or resolution determination function may reside in another, or in only one of the units controlling a display.

Simultaneous move chess shares the following rules with traditional chess: a) played by two players (except in the case of multiple players as described below); b) each player has the same number of pieces; c) the number and type of pieces are generally the same as traditional chess, or any traditional variation of chess as the case may be; and d) each piece has fixed rules for moving (the rules of moving are generally the same as traditional chess, or any traditional variation of chess as the case may be, subject to certain additional restrictions or modifications as described in the rules below).

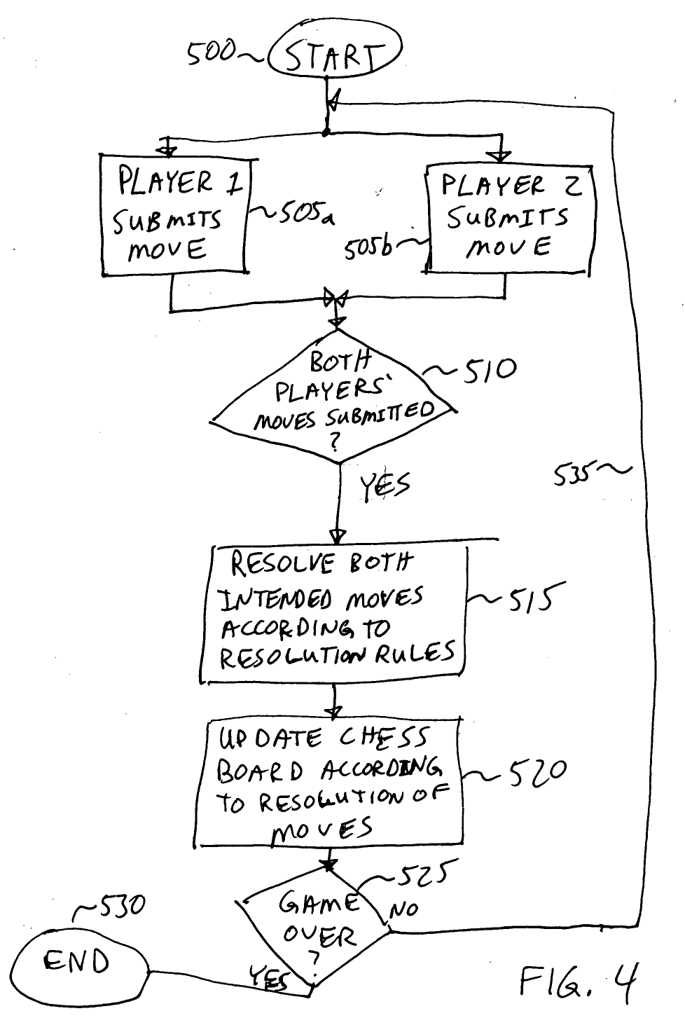

A flow chart of basic simultaneous move chess is shown in FIG. 4. After the game is started in step 400, Player 1 submits its move in step 505a and Player 2 submits its move in step 505b at the same time (“simultaneous move”). Only legitimate moves are permitted. If a player submits an illegal move, the move will be disallowed, and the player may or may not be penalized. The game pauses at step 510 until both players' moves are submitted. In step 515, both intended moves are resolved according to a set of resolution rules (see below) and the outcome is determined. In step 520, the outcome is used to update the chess board. If the game is over at this point, as determined in step 525, the game ends 530. Otherwise, path 535 is followed to the top of the flow chart.

In one embodiment of simultaneous move chess, the pieces are the same as international chess. Also, all moves permitted in international chess are also allowed in this embodiment of simultaneous move chess. These rules may be modified to correspond to other types of chess, including Chinese chess, Indian chess, etc. in other embodiments. The basic resolution rules in this embodiment are:
1) In addition to moves permitted in a normal international chess game, a move otherwise permitted in normal international chess that causes a piece to land on another piece of the same side (“friendly piece”) (which would not be permitted in a normal chess game) is also permitted. This is referred to as a “guard” move. In a “guard” move, the location of the friendly piece on which the moving piece would otherwise land is the “guarded square” or “guarded location.” A guard move may not be used to guard an empty location or a location occupied by an enemy piece. The purpose of this rule change is provided below in (2)-(5).
2) If both players submit legitimate non-guard moves that land on different locations or if one player submits a legitimate guard move to a square not guarded by the opponent, the outcome of the non-guard moves are the same as normal international chess, namely, (a) if the location is not occupied, the piece making the move occupies the location and (b) if the location is occupied by an enemy piece, the enemy piece is eliminated and the moving piece occupies the location.
3) If both players submit legitimate guard moves, no action is taken and play continues to the next move.
4) If one player submits a legitimate move that lands on the same location that is “guarded” by an opposing player's “guard” move: a) the piece that originally occupied the location at the beginning of the turn is eliminated; b) the enemy piece that seeks to occupy the location is eliminated; and c) the guarding piece occupies the guarded location.
5) A guard move only operates for that turn. If the opponent moves to the guarded location on the next turn and the guard move is not repeated for that location, rule (4) does not apply.
6) If both players submit legitimate moves to the same empty location (if the square is not empty, one of the moves would be a guard move and treated as described above), the lower ranked piece is eliminated and the higher ranked piece is placed in the location. The ranking of pieces, from high to low, is queen, rook, bishop/knight, pawn, king. If both pieces being moved into the same empty location have the same rank, both pieces are eliminated.
7) Note that it is permissible for pieces to exchange position as a result of one trying to occupy the location of the other. The apparent “cross over” has no effect.
8) The king may be captured (e.g., see rule (6)), ending the game with the same result as a checkmate or resignation.

In some embodiments, there are variations to the basic resolution rules. Any number of variations may be combined for use in one game. Some variations have sub-variations options that may be mutually exclusive to each other or in addition to the main variation. The variations to be used in a particular game may be chosen by a game or server administrator or by one of the players.

In variation A, no guard moves are allowed.

In variation B, guard moves do not expire after a single move, but last up to a predetermined number of moves (including lasting the entire remainder of the game). The precise predetermined number used is a sub-variation. In this variation, once a guard move is made, the guarded location is guarded by the guarding piece until any one of the following occur: (1) the predetermined number of moves take place; (2) the guarding piece moves or is captured; (3) the guarding piece is used as the guarding piece in a new guard move for a different location; or (4) the guarded piece moves or is captured.

In variation B (as well as variations (C) and (D) below), it is possible for multiple pieces of a player to guard the same location. It is also possible for both players to being guarding the same location with one or more guarding pieces each. In these cases, if a guarded location is moved into by an attacking piece, the number of the defender's pieces guarding that location and the number the attacker's pieces guarding that location (if any) are counted. In all these cases, the piece at the guarded location at the beginning of the turn and the attacking piece are eliminated.

In variation B, if the defender has more pieces guarding the location than the attacker, all of the attacker's pieces guarding the location are also eliminated. From the pieces that the defender has guarding the location, the defender must then choose the same number of pieces as the attacker had guarding the location (not including the attacking piece itself) and these are also eliminated. The defender then chooses which of the remaining pieces guarding the location to move into the guarded location.

In variation B, if the attacker has the same number or more pieces guarding the location than the defender, all of the defender's pieces guarding the location are also eliminated. From the pieces that the attacker has guarding the location, the attacker must then choose the same number of pieces as the defender had guarding the location (not including the attacking piece itself) and these are also eliminated. The attacker then chooses which of the remaining pieces guarding the location to move into the guarded location.

In sub-variation B1 of variation B, the guard moves may be hidden, partially hidden, or open. If the guard moves are hidden, the opponent is advised that a guard move has been made, but is not advised of the identity of the guarding piece or the guarded piece. In partial hidden guard moves, either the guarding piece or the guarded piece is identified, but not both. In further sub-variations of the partially hidden sub-variation, the guarding piece is always identified, the guarded piece is always identified, the player making the guarding move decides whether the guarded piece or guarding piece is identified, or the opponent of the player making the guarding move decides whether to disclose the guarded piece or guarding piece is identified. In the open sub-variation, both the guarded piece and the guarding piece are always disclosed to the opponent of the player making the guard move.

In variation C, players are allowed unlimited guard moves. In this variation, though, a player must submit a legitimate (non-guard) move every turn in addition to any guard moves.

In variation D, all possible guard moves are automatically made every turn even if a player does not want to. In this variation, also, a player must submit a legitimate (non-guard) move every turn. This variation is similar to the “must jump” variation in checkers.

In variation E, the basic resolution rule for simultaneous movement into the same empty location by both players is modified. Rather than basic resolution rule (6), above, where the piece with the lower rank is eliminated, one of the following sub-variations may be used: El) a different ranking system than set forth in rule (6) is used. For example, the ranking could be reversed. In another example, bishops are ranked higher than knights rather than being ranked the same as knights; E2) if both pieces are the same rank, neither are eliminated, but their moves are both nullified and neither piece moves that turn. (This sub-variation may be combined with sub-variation E1); E3) both pieces are eliminated, regardless of rank; and E4) neither piece is eliminated, regardless of rank, but their moves are both nullified and neither piece moves that turn.

In one embodiment of simultaneous move Chinese chess, the basic resolution rules for international chess are used with “international” replaced by “Chinese” with the following additional rules:
1) Additional note that for a “cannon”, a jump-over move is legitimate if there is a piece in the destination location, but unlike the case of normal Chinese chess, the piece in the destination location does not need to be an enemy piece.
2) In Chinese chess, the King (or Commander) is confined to move within a special zone consisting of 9 locations including and in the vicinity of the King's initial position. This zone symbolizes the Palace. Normally, this zone is well guarded. However, in Simultaneous Chess, the concept of “guarding” is weakened (even with variations C and D), since in order for the guarding of a piece to be effective, the piece must be actually attacked rather than just threatened. To balance this, a “no stop” rule is introduced, which states that an enemy piece entering the Palace cannot remain in the Palace, but must retreat outside of the Palace. Failure to do so would result in the elimination of the piece. Other potential rules that might have similar effects and therefore are substitutes of this rule include: a) one stop” or “N stop” rule, which allows an enemy piece to remain within the Palace, whether in the same location or not, for one or N steps; and b) “Freeze” rule, which states that an enemy piece which enters a Palace will be “frozen” for one move.

In some embodiments, the following additional rules and variations are incorporated to increase the richness and change the balance of the game. Different embodiments have different ones or combinations of these additional rules and variations.

One additional rule, called Initial formation, allows one side to make N moves in a row while confining its pieces all within its own territory. This is meant to recreate the concept of setting up a formation before a battle. The determination of N (N can be 0, 1 2, . . . ) can be based on handicap, chance or consensus.

Another additional rule allows the chess game to be extended into a game of 4 players without any change in the basic layout of each side. The party which eliminates the Kings of the other three players wins. All other rules remain the same.

The preceding description has been presented with reference to presently preferred embodiments of the invention. Persons skilled in the art and technology to which this invention pertains will appreciate that alterations and changes in the described structure may be practiced without meaningfully departing from the principle, spirit, and scope of this invention. Accordingly, the foregoing description should not be read as pertaining only to the precise system and method described and illustrated in the accompanying drawings, but rather should be read consistent with and as support for the following claims, which are to have their fullest and fairest scope.

What is claimed is:

1. A system for allowing the playing of a game of simultaneous move chess comprising:
one or more inputs that receive intended move commands from at least two players; and
a processor that determines the results of the intended move commands after intended move commands are received for all players in the game, the determination including,
interpreting intended moves that result in a player's piece landing in square occupied by another of that player's pieces as a guard move,
if an attacking player's intended move is to an attacked square occupied by a defending player's piece and the defending player's intended move is a guard move to the same square, eliminating the attacking player's piece in the attacking player's intended move, eliminating the defending player's piece in the attacked square and moving the defending player's piece making the intended guard move to the attacked square; and
if a defending player's intended move is a guard move of square that is not an ending square of an attacking player's intended move, not moving any of the defending player's pieces until at least a next turn;
wherein the processor outputs instructions for updating a display of a chess board according to the determined results of the intended move commands.

2. The system of claim 1 wherein the processor is a web server and the inputs receive intended move commands from users over a network.

3. The system of claim 2 wherein the network is the Internet.

4. A method of playing of a game of simultaneous move chess comprising:
receiving intended move commands from at least two players;
determining the results of the intended move commands after intended move commands are received for all players in the game, the determination including,
interpreting intended moves that result in a player's piece landing in square occupied by another of that player's pieces as a guard move,
if an attacking player's intended move is to an attacked square occupied by a defending player's piece and the defending player's intended move is a guard move to the same square, eliminating the attacking player's piece in the attacking player's intended move, eliminating the defending player's piece in the attacked square and moving the defending player's piece making the intended guard move to the attacked square; and
if a defending player's intended move is a guard move of square that is not an ending square of an attacking player's intended move, not moving any of the defending player's pieces until at least a next turn; and
outputing instructions for updating a chess board according to the determined results of the intended move commands.

5. The method of claim 3 wherein the determining is performed by a web server and the intended move commands are received from users over a network.

6. The method of claim 5 wherein the network is the Internet.
